(19) United States
(12) Patent Application Publication
(10) Pub. No.: US 2007/0085823 A1
(43) Pub. Date: Apr. 19, 2007

(54) Data encoding pattern

(75) Inventor: Guy de Warrenne Bruce Adams, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/491,952

(22) Filed: Jul. 25, 2006

(30) Foreign Application Priority Data
Oct. 13, 2005 (GB) 0520775.8

(51) Int. Cl. G09G 5/00

(52) U.S. Cl. 345/156

(57) ABSTRACT

A data encoding pattern comprising a plurality of markings, the shape of at least one marking adapted on the basis of the data to be encoded, the or each adapted marking having a specific orientation with respect to unadjusted markings for the pattern.

### CLAIM TO PRIORITY

This application claims priority from co-pending United Kingdom utility application entitled, “Data Encoding Pattern” having serial no. GB 0520775.8, filed Oct. 13, 2005, which is entirely incorporated herein by reference.

### FIELD OF THE INVENTION

The present invention relates generally to a data encoding pattern, and more specifically, 10 but not exclusively, to a data encoding pattern suitable for use with a digital pen and paper system.

### BACKGROUND

Many digital pen and paper systems have been proposed. One that is in use is the Anoto system, which can be implemented using a device such as the Logitech IO2 pen, available from Logitech of 6505 Kaiser Drive, Fremont, Calif. 94555, USA. Generally, using such technology, the pen senses a position determining pattern that has been printed onto a page of digital paper and an evaluation of the pen's position, and movements, is made using data collected by the pen.

WO 03/046708 discloses a system of this kind. In the known Anoto type arrangements, the pen is connected by a Universal Serial Bus (USB) cable or wirelessly to a processing device such as a mobile telephone or a personal computer. The processing device receives data from the pen and can identify a document which has been marked by the pen. This can result in the processing device determining information about how the document should be handled. This information may identify an application, perhaps stored on the processing device or held remotely, which enables the information from the pen to be processed.

Currently, in such systems, a coding pattern on the digital paper consists of a number of markings printed on the paper in a specific configuration. Constraints in imaging technology used to discriminate the markings printed on a page limit the minimum effective distance between distinct markings, and therefore a coding density of the system. For example, if two markings are placed close together on a coded surface such that they overlap/merge there is an increased optical difficultly in discriminating between the markings. In addition the resulting visual effect is immediately noticeable because of the local increase in effective marking size.

U.S. patent application Ser. No. 10/695,542 describes a coding pattern for use with a digital pen and paper system. In FIG. 1 thereof, the use of a guard band is illustrated, such that when markings are printed onto a surface, none of the associated coding permutations cause them to overlap or merge thus preventing difficulty in discrimination. A coding density of the digital paper is not optimized, however.

### SUMMARY

According to a first aspect of the present invention, there is provided a data encoding pattern comprising a plurality of markings, the shape of at least one marking adapted on the basis of the data to be encoded, the or each adapted marking having a specific orientation with respect to unadjusted markings for the pattern.

According to second aspect of the present invention, there is provided an optically detectable data encoding layout for a surface, the data encoding layout comprising, a lattice including one or more markings composed from sub-markings, wherein at least one of the markings is a shape-adjusted marking composed from sub-markings arranged in a specific orientation, the orientation determined on the basis of a location of the or each adjusted marking on the lattice.

According to a third aspect of the present invention, there is provided a method of encoding data for use with a carrier, the method comprising, determining a configuration of markings to be printed on the carrier, each marking composed of a plurality of sub-markings, and on the basis of the determination, adjusting an arrangement of sub-markings used to generate at least one marking in order to generate a shape adjusted marking.

### BRIEF DESCRIPTION OF THE FIGURES

For a better understanding of the present invention, and to further highlight the ways in which it may be brought into effect, embodiments will now be described, by way of example only, with reference to the following drawings in which:-

FIG. 1 is a schematic representation of a portion of a square primary lattice with primary markings at each lattice point;

FIG. 2 is a schematic representation of the primary lattice portion of FIG. 1 populated with secondary markings;

FIG. 3a is a schematic representation of a more detailed portion of a primary lattice with markings in payload, or interstitial, areas between the primary lattice points;

FIG. 3b is a schematic representation of a marking of FIG. 3a and the dots used to form the marking shown in greater detail;

FIG. 4 is a schematic representation of a detailed portion of a payload area of a primary lattice portion according to an embodiment; and

FIG. 5 is a schematic representation of a coding configuration in which a primary marking has been removed.

It should be emphasized that the term “comprises/comprising” when used in this specification specifies the presence of stated features, integers, steps or components but does not preclude the presence or addition of one or more other features, integers, steps, components or groups thereof.

### DETAILED DESCRIPTION OF THE PREFERRED EMBODIMENTS

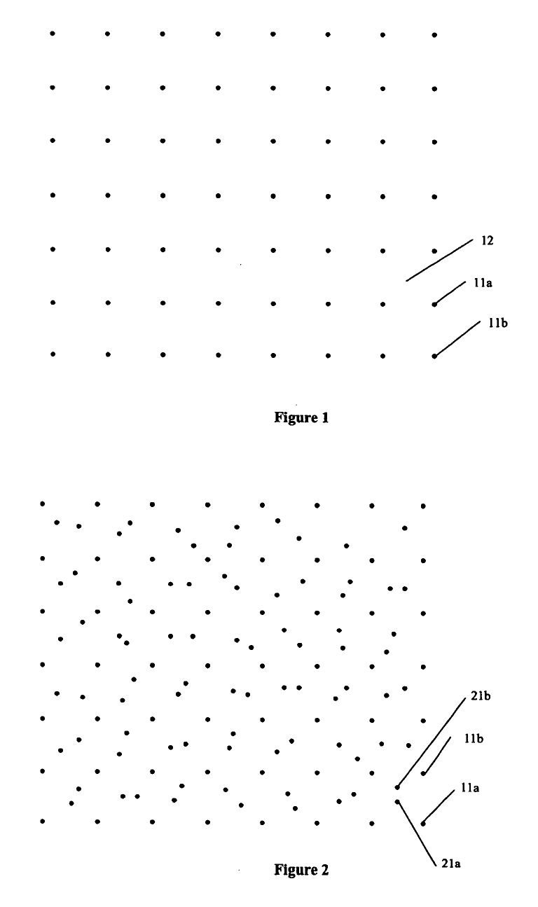

FIG. 1 is a schematic representation of a primary lattice of an exemplary digital paper coding system wherein each lattice point 11a, 11b, . . . is populated by a primary marking. The primary lattice is regular with a square unit shape. The function of the primary lattice is generally to define and allow the areas 12.

The payload, or interstitial, areas 12 between lattice points of the primary lattice are populated with secondary markings, thereby forming secondary lattices. FIG. 2 is a schematic representation of a primary lattice including exemplary payload (interstitial markings 21a and 21b per unit cell 12. The secondary markings are termed payload as they are carried in a specified region between the primary lattice points. Insertion of the secondary markings reduces any regularly repeating intrusive optical effect of the regular lattice pattern in the primary lattice, and serves to encode data by means of their position within the payload area 12. It will be appreciated that other coding systems can be used. For example, markings of the primary lattice can be offset in a particular direction, with no secondary lattice markings. Other alternatives are also possible.

Detectable markings used for a digital paper coding system when printed using a laser or inkjet printer for example, are typically formed from a cluster of smaller (than the marking) dots printed in close proximity so as to create a reliable marking. In general, dot gain will occur, in which the diameter of the dot grows due to charge dissipation in laser marking engines or with inkjet the ink used to print the dot, leaches into the carrier (e.g. paper) upon which it is printed. This can result in a larger than desired size for the dot. Furthermore, current systems tend to add undesirable elements to a printed dot, such as a tail for example. The provision of using a plurality of dots to generate a reliable marking can help obviate the undesirable effects described above, since the dots can be placed in an arrangement which reduces any dot ‘tails’ and/or ‘satellite’ droplets (see for example, Applicant's co-pending U.S. patent application, Ser. No. 10/974,370 entitled ‘Method for Preparing a Print Mask’). In addition, current systems can, on occasion, fail to print a dot, for example due to a lack of toner or a blocked nozzle resulting in loss of the dot in question before printing. If more than one dot is used to generate a marking, that marking can be printed much more reliably. It will be appreciated that, in general, a reliable marking can be composed from at least two dots, and preferably four, but more or less than this can be used, and the above is not intended to be limiting.

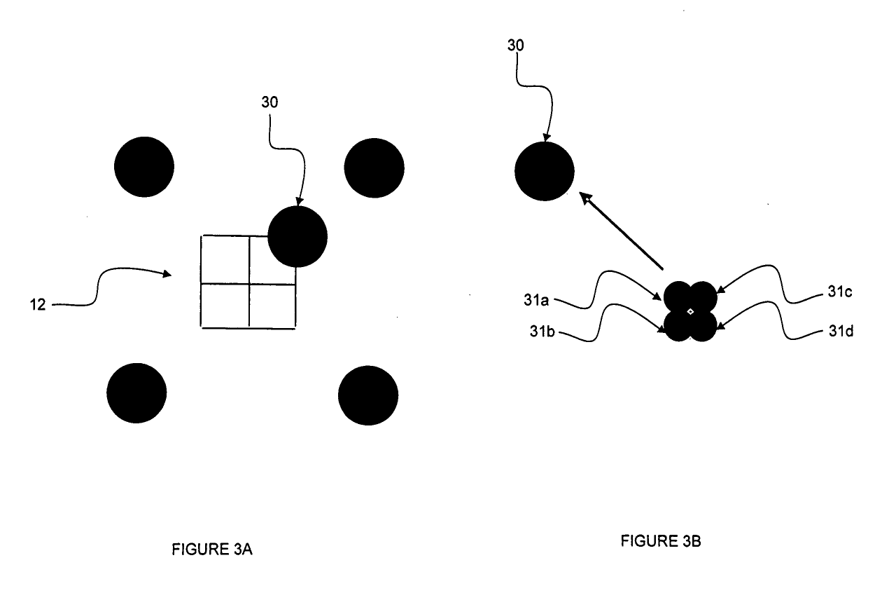

When viewed or imaged, the cluster is generally indistinguishable from a larger marking. In this connection, FIG. 3a is a schematic representation of the payload area 12 of FIG. 2 shown in greater detail. A reliable secondary marking 30 is located in the payload area 12. The marking 30 is formed, in this case, from four smaller markings (dots) 31a-d printed in close proximity as illustrated in FIG. 3b. Due to dot gain, for example, the four dots 31a-d effectively merge to create the marking 30.

A secondary marking 30 (or another primary marking) must be placed a minimum distance from a primary marking in order that the markings in question do not overlap/merge, or appear to do so by virtue of their close proximity. The minimum distance ensures that the markings remain visually distinct and are capable of being imaged, for example using a camera of a digital pen. Also, if markings are placed too close together this will begin to affect the medium upon which the markings are printed, for example, by appearing to give the medium a different colour than that which was intended.

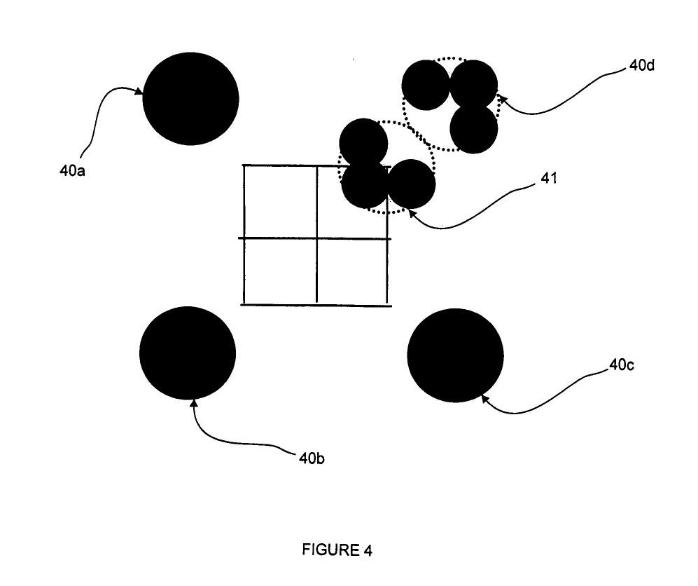

According to an embodiment, a reliably detectable marking is constructed using a specific dot configuration. Typically, this is achieved using three, or less, dots, but it will be appreciated that, according to the system being used to print/image the markings, more or less can be used as appropriate. The dots from which a marking is composed are arranged in a specific disposition to ensure that markings, such as primary and secondary markings, are individually optically distinguishable, and can be placed in closer proximity than the case where the marking was not composed from specifically arranged dots. FIG. 4 is a schematic representation of a detailed portion of a payload area 12 according to an embodiment which illustrates the composition and orientation of a marking constructed using three dots.

The area 40 comprises four primary markings 40a-d at each lattice point of a primary lattice, and a secondary marking 41 in an interstitial area between the primary markings 40a-d. Markings 40d and 41 are respectively composed of three dots. The dots from which the markings are formed are smaller than a desired size of a final marking. At a resolution used to view or image markings, markings 40d and 41 are distinguishable as individual (separate) markings. The secondary markings are used to encode data by virtue of their respective positions in the interstitial sites of the primary lattice. The positions of the secondary markings in the payload areas relative to the primary lattice encode data in some predetermined manner. See for example, the Applicant's co-pending U.S. patent application, Ser. No. 10/695,452, the disclosure of which is entirely incorporated herein by reference.

Distinguishable markings, such as 40d or 41, which are composed of three or less dots for example, have a specific orientation by virtue of the arrangement of the intrinsic dots forming the marking on the printed medium. The orientation is determined on the basis of a desired disposition of primary and secondary markings. For example, a coding pattern of primary and secondary markings to be printed onto a product (such as digital paper for example) can be analysed, before or during printing for example, in order to determine if there are any coding conditions present wherein a primary and secondary marking are to be printed in close proximity. If such a condition is detected, at least one of the primary or secondary markings can be formed from dots with a specific orientation. Advantageously, the markings are composed from three or less dots. The arrangement of the dots enables the coding density of the markings to be maximized. The markings can be placed in close proximity, whilst still permitting them to be optically (and/or visually) distinguishable from one another. The markings can be placed far enough apart to ensure that any undesirable apparent discolouration of the medium upon which they are printed does not occur, such that the visual impact of the proximity of the markings is also taken into account in determining how close together certain marking should be placed to one another.

In the example of FIG. 4, markings 40d and 41 are in the form of juxtaposed ‘L’ shapes, which ensures the markings remain individually detectable, but are closer together than would be possible if they had been constructed from four (or more) dots.

The circular dotted lines of 40d and 41 represent notional markings formed from four dots. The proximity of the markings when formed from four dots would result in them being indistinguishable when imaged. It also shows that the clusters are centered at the same position as if the markings had been formed from four dots.

According to an embodiment, potential errors in finding the centre of a cluster of dots forming a marking, i.e. the centre of a marking, can be reduced using knowledge of the fact that a specific dot cluster is used under for a specific condition. Compensation can therefore be applied to correct a centre detection error. More specifically, any offset in the position of a primary marking can be compensated for using the position of other primary markings forming the primary lattice. An offset primary marking will not, therefore, be mistaken for a secondary marking.

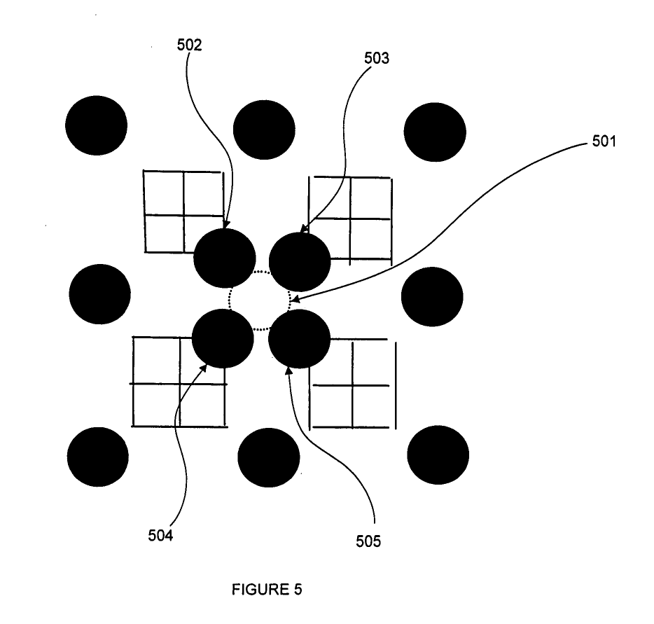

If there is more than one secondary marking located in close proximity to a primary marking, the primary marking can be removed altogether. FIG. 5 is a schematic representation of a configuration in which a primary marking has been removed. The dotted circular line in FIG. 5 represents the location of the missing primary marking 501. Advantageously, the missing marking can help to identify the fixed (primary) grid (lattice) by virtue of the fact that there is not a primary marking in that position, i.e. when determining a notional primary lattice using other primary markings of the grid, the lack of a primary marking at a particular site will serve to reinforce the determination. Secondary (coding) markings 502, 503, 504, 505 do not need to be composed of three, or less, dots in this case as they will not overlap or merge with a primary marking (501) due to its removal

1. A data encoding pattern comprising a plurality of markings, the shape of at least one marking adapted on the basis of the data to be encoded, the or each adapted marking having a specific orientation with respect to unadjusted markings for the pattern.

2. A data encoding pattern as claimed in claim 1, wherein the shape of the or each marking is adapted by:
determining an arrangement for markings of the pattern for encoding data;
using the determined arrangement to determine if any markings are to be placed in a predetermined configuration; and
on the basis of the determination adapting a shape of markings to be placed in the configuration.

3. A data encoding pattern as claimed in claim 1, wherein adapting a shape of a marking comprises adapting a size of the marking.

4. A data encoding pattern as claimed in claim 1, wherein the plurality of markings are respectively generated for the pattern from sub-markings, the shape of the or each marking adapted by adjusting at least one of an arrangement and number of sub-markings for a marking.

5. A data encoding pattern as claimed in claim 1, wherein the shape of the or each marking is adapted to be in the form of an “L” shape.

6. An optically detectable data encoding layout for a surface, the data encoding layout comprising:
a lattice including one or more markings composed from sub-markings, wherein at least one of the markings is a shape-adjusted marking composed from sub-markings arranged in a specific orientation, the orientation determined on the basis of a location of the or each adjusted marking on the lattice.

7. An optically detectable data encoding layout as claimed in claim 6, wherein the or each shape-adjusted marking comprises fewer sub-markings than the markings which are not shape-adjusted.

8. An optically detectable data encoding layout as claimed in claim 6, wherein the lattice is a secondary lattice formed in an interstitial area formed by a primary lattice defined by a plurality of primary markings located at the vertices of the primary lattice, and wherein determining an orientation of the or each shape-adjusted marking further comprises:
determining the proximity of a marking of the secondary lattice to another marking in the secondary lattice or to a primary marking; and
on the basis of the determination arranging sub-markings of a shape-adjusted marking in order to allow the shape-adjusted marking to be located a minimum distance from the another marking whilst maintaining an optical detectability of the adjusted and the another marking.

9. An optically detectable data encoding layout as claimed in claim 8, wherein some vertices of the primary lattice do not comprise primary markings.

10. An optically detectable data encoding layout as claimed in claim 7, wherein the primary markings are composed from sub-markings.

11. An optically detectable data encoding layout as claimed in claim 10, wherein a primary marking can be a shape-adjusted primary marking by virtue of the arrangement of sub-markings for that primary marking.

12. A method of encoding data for use with a carrier, the method comprising:
determining a configuration of markings to be printed on the carrier, each marking composed of a plurality of sub-markings; and
on the basis of the determination, adjusting an arrangement of sub-markings used to generate at least one marking in order to generate a shape adjusted marking.

13. A method as claimed in claim 12, wherein the shape adjusted marking is generated using sub-markings having a specific arrangement, the arrangement adapted to enable the shape adjusted marking to be printed closer to another marking than would otherwise be possible whilst maintaining optical detectability of the shape adjusted and the another marking.

14. A method as claimed in claim 12, further comprising:
analysing a configuration of markings for a data encoding pattern;
on the basis of the analysis, generating disposition data representing a disposition for markings; and
using the disposition data to determine a marking suitable for adjustment.
